(19) United States
(12) Patent Application Publication
(10) Pub. No.: US 2015/0122457 A1
(43) Pub. Date: May 7, 2015

(54) SYNTHETIC JET ACTUATOR EQUIPPED WITH A PIEZOELECTRIC ACTUATOR AND A VISCOUS SEAL

(71) Applicant: NUVENTIX, INC., Austin, TX (US)

(72) Inventors: John Stanley Booth, Austin, TX (US); Markus Schwickert, Scottsdale, AZ (US); Raghavendran Mahalingam, Austin, TX (US)

(73) Assignee: NUVENTIX, INC., Austin, TX (US)

(21) Appl. No.: 14/194,695

(22) Filed: Mar. 1, 2014

Related U.S. Application Data
(60) Provisional application No. 61/771,289, filed on Mar. 1, 2013.

(51) Int. Cl. F15D 1/00

(52) U.S. Cl. CPC F15D 1/008; F15D 1/0095
USPC 165/84; 165/104.34

(57) ABSTRACT

A method is provided for operating a thermal management system which includes providing a set of synthetic jet actuators A={a₁, . . . , aₙ} (309, 311, 313), wherein n≧3, and wherein each member of A has a diaphragm which oscillates along a principle axis. The members of set A are arranged and operated such that they have corresponding forces F₁, . . . , Fₙ at any given time during their operation, wherein any force Fₖ ε {F₁, . . . , Fₙ} has vector components along mutually orthogonal axes x, y and z of Fₖₓ, F_{ky}, and F_{kz}, wherein at least one of the sets Sₓ={|F₁ₓ|, . . . , |Fₙₓ|}, S_{y}={|F_{1y}|, . . . , |F_{ny}|} and S_{z}={|F_{1z}|, . . . , |F_{nz}|} has more than one member, and wherein the sum T_{F}=Σᵢ₌₁ⁿ Fᵢ is essentially zero.

### CROSS-REFERENCE TO RELATED APPLICATION

This application claims the benefit of U.S. provisional application No. 61/771,289, filed Mar. 1, 2013, having the same title, and the same inventors, and which is incorporated herein by reference in its entirety.

### FIELD OF THE DISCLOSURE

The present disclosure relates generally to synthetic jet ejectors, and more particularly to systems and methods for affecting vibration cancellation in the same.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile thermal management solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows”; U.S. Pat. No. 6,056,204 (Glezer et al.), entitled “Synthetic Jet Actuators for Mixing Applications”; U.S. Pat. No. 6,123,145 (Glezer et al.), entitled Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques”.

Further advances have been made in the art of synthetic jet ejectors, both with respect to synthetic jet ejector technology in general and with respect to the applications of this technology. Some examples of these advances are described in U.S. 20100263838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System”; U.S. 20090084866 (Grimm et al.), entitled Vibration Balanced Synthetic Jet Ejector”; U.S. 20080295997 (Heffington et al.), entitled Synthetic Jet Ejector with Viewing Window and Temporal Aliasing”; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20080006393 (Grimm), entitled Vibration Isolation System for Synthetic Jet Devices”; U.S. 20070272393 (Reichenbach), entitled “Electronics Package for Synthetic Jet Ejectors”; U.S. 20070141453 (Mahalingam et al.), entitled “Thermal Management of Batteries using Synthetic Jets”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; U.S. 20070141453 (Mahalingam et al.), entitled “Thermal Management of Batteries using Synthetic Jets”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; and U.S. Pat. No. 7,819,556 (Heffington et al.), entitled “Thermal Management System for LED Array”.

### BRIEF DESCRIPTION OF THE DRAWINGS

FIGS. 1a-1c are illustrations depicting the manner in which a synthetic jet actuator operates.

FIG. 2 is a side view illustration of a configuration of actuators that has only a single direction of force, and wherein the actuators are arranged so that the forces are equal and opposite. They also have no net moment about the axis of the cone. An arrangement of this type may be utilized to provide straightforward vibration minimization.

FIG. 3 is a side view illustration of a configuration with two of the actuators positioned similarly to those in FIG. 2, except they have been tilted to follow the outline of the cone. In this case there is a net force along the z-axis of the cone. The third actuator is positioned symmetrically about the cone axis. In this arrangement, the third actuator may be driven so that its force is opposite in phase and cancels the z component of the first two actuators. An arrangement of this type may be utilized to achieve zero net force and moment, thus providing the desired vibration elimination.

FIG. 4 is a top view illustration of the end view of a cone or cylinder, typical for a standard (PAR/R) light bulb or lighting fixture. In this configuration, the three actuators are placed with 120° spacing and with their forces perpendicular to, and passing through, the z-axis of the cone. An arrangement of this type may be utilized to achieve cancellation of the x and y force components when the three actuators are driven in phase. Moreover, the individual net forces of the actuators pass through the cone axis so there is zero moment. Thus, arrangement of this type may be utilized to eliminate vibration.

FIG. 5 is a top view illustration of an arrangement similar to FIG. 4, except that the embodiment depicted includes four actuators which are arranged such that they are not attached in paired equal and opposite positions, but are mounted with their individual force vectors passing the through the axis of the cone. For this case, zero force is obtained by modifying the magnitude of the displacement drive signals and/or the mass of the moving elements of the actuators so as to give a net zero force. This approach provides more package design flexibility to meet external constraints or to optimize cooling, and eliminates vibration.

FIG. 6 is an illustration that extends the FIG. 5 arrangement to include compensation for the more general case when the FIG. 5 actuators are mounted such that there is a net z-axis force. In this case, the actuator at the base of the cone provides the balancing force similar to the description above for FIG. 3.

### SUMMARY OF THE DISCLOSURE

In one aspect, a method is provided for operating a thermal management system which includes providing a set of synthetic jet actuators A={a₁, . . . , aₙ}, wherein n≧3, and wherein each member of A has a diaphragm which oscillates along a principle axis. The members of set A are arranged and operated such that they have corresponding forces F₁, . . . , Fₙ at any given time during their operation, wherein any force Fₖ ε {F₁, . . . , Fₙ} has vector components along mutually orthogonal axes x, y and z of Fₖₓ, F_{ky}, and F_{kz}, wherein at least one of the sets Sₓ={|F₁ₓ|, . . . , |Fₙₓ|}, S_{y}={|F_{1y}|, . . . , |F_{ny}|} and S_{z}={|F_{1z}|, . . . , |F_{nz}|} has more than one member, and wherein the sum T_{F}=Σᵢ₌₁ⁿ Fᵢ is essentially zero.

### DETAILED DESCRIPTION

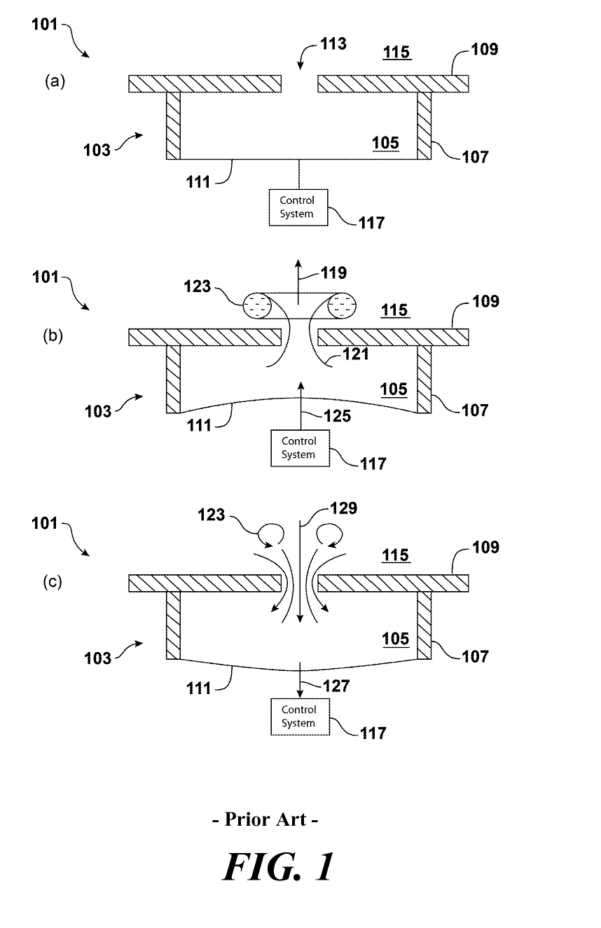

The structure of a synthetic jet ejector may be appreciated with respect to FIG. 1a. The synthetic jet ejector 101 depicted therein comprises a housing 103 which defines and encloses an internal chamber 105. The housing 103 and chamber 105 may take virtually any geometric configuration, but for purposes of discussion and understanding, the housing 103 is shown in cross-section in FIG. 1a to have a rigid side wall 107, a rigid front wall 109, and a rear diaphragm 111 that is flexible to an extent to permit movement of the diaphragm 111 inwardly and outwardly relative to the chamber 105. The front wall 109 has an orifice 113 therein which may be of various geometric shapes. The orifice 113 diametrically opposes the rear diaphragm 111 and fluidically connects the internal chamber 105 to an external environment having ambient fluid 115.

The movement of the flexible diaphragm 111 may be controlled by any suitable control system 117. For example, the diaphragm may be moved by a voice coil actuator. The diaphragm 111 may also be equipped with a metal layer, and a metal electrode may be disposed adjacent to, but spaced from, the metal layer so that the diaphragm 111 can be moved via an electrical bias imposed between the electrode and the metal layer. Moreover, the generation of the electrical bias can be controlled by any suitable device, for example but not limited to, a computer, logic processor, or signal generator. The control system 117 can cause the diaphragm 111 to move periodically or to modulate in time-harmonic motion, thus forcing fluid in and out of the orifice 113.

Alternatively, a piezoelectric actuator could be attached to the diaphragm 111. The control system would, in that case, cause the piezoelectric actuator to vibrate and thereby move the diaphragm 111 in time-harmonic motion. The method of causing the diaphragm 111 to modulate is not particularly limited to any particular means or structure.

The operation of the synthetic jet ejector 101 will now be described with reference to FIGS. 1b-FIG. 1c. FIG. 1b depicts the synthetic jet ejector 101 as the diaphragm 111 is controlled to move inward into the chamber 105, as depicted by arrow 125. The chamber 105 has its volume decreased and fluid is ejected through the orifice 113. As the fluid exits the chamber 105 through the orifice 113, the flow separates at the (preferably sharp) edges of the orifice 113 and creates vortex sheets 121. These vortex sheets 121 roll into vortices 123 and begin to move away from the edges of the orifice 109 in the direction indicated by arrow 119.

FIG. 1c depicts the synthetic jet ejector 101 as the diaphragm 111 is controlled to move outward with respect to the chamber 105, as depicted by arrow 127. The chamber 105 has its volume increased and ambient fluid 115 rushes into the chamber 105 as depicted by the set of arrows 129. The diaphragm 111 is controlled by the control system 117 so that, when the diaphragm 111 moves away from the chamber 105, the vortices 123 are already removed from the edges of the orifice 113 and thus are not affected by the ambient fluid 115 being drawn into the chamber 105. Meanwhile, a jet of ambient fluid 115 is synthesized by the vortices 123, thus creating strong entrainment of ambient fluid drawn from large distances away from the orifice 109.

Despite the many advances in synthetic jet ejector technology, a need for further advances in this technology still exists. For example, the moving diaphragm in many synthetic jet ejectors creates a force that may be transmitted from the synthetic jet ejector to the assembly to which it is attached. It is desirable, or required, to minimize this force transmission and the related vibration of the overall assembly to which it is attached.

In applications that permit it, the actuators may be symmetrically disposed in a housing in a face-to-face or back-to-back arrangement, and on the same central axis. Consequently, when they are driven to move in equal and opposite motion and at the same frequency, their forces and moments will cancel each other, thereby minimizing or eliminating vibration problems.

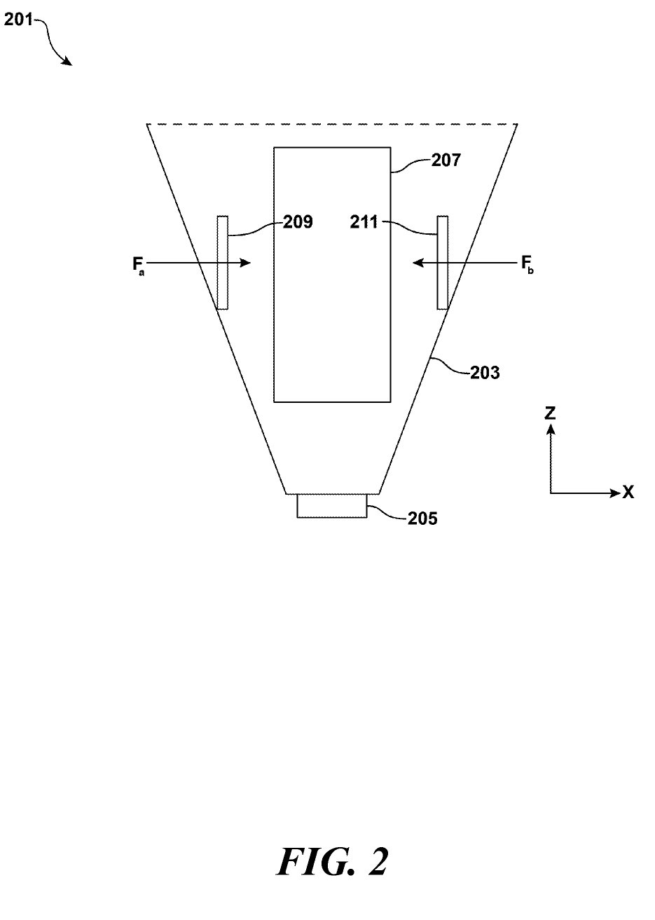

Such a configuration is depicted in FIG. 2. The illumination device 201 depicted therein has a cone 203 with a PAR/R standard shape and an electrical/mechanical attachment 205 (this is typically a threaded screw cap and electrical contact of the type that rotatingly engages an Edison socket). An assembly 207 of one or more light sources and optical components are seated within the cone 203. First 209 and second 211 synthetic jet ejectors are positioned in the cone in an arrangement in which the respective forces Fₐ and F_{b} (and associating moments) are equal in magnitude but opposite in sign, and hence cancel each other out.

However, when it is not possible or feasible to package the synthetic jet ejectors in a symmetrical arrangement as in FIG. 2, the cancellation of moments and forces may not occur, and hence, vibration may become a problem. This problem is especially pronounced when the synthetic jet ejectors need to be placed on the surfaces of cones or cylinders, as would be the case in various standard lighting and light bulb fixtures. In such applications, it may be necessary for the synthetic jet actuators to be placed off-axis and/or at various angles on the sides of a cone, or at intermediate positions between the cone axis and its sides (e.g., higher or lower along such lines). Such a disposition may result in essentially no symmetry with respect to the position or direction of the resultant forces. This may also ban issue for other applications where package geometries do not allow the symmetry required for simple vibration cancellation of the type depicted in FIG. 2.

It has now been found that the foregoing problem may be addressed through arrangements of synthetic jet actuators in such a way that the forces and moments cancel each other, even when straightforward symmetry is not possible, not practical or does not give adequate vibration elimination.

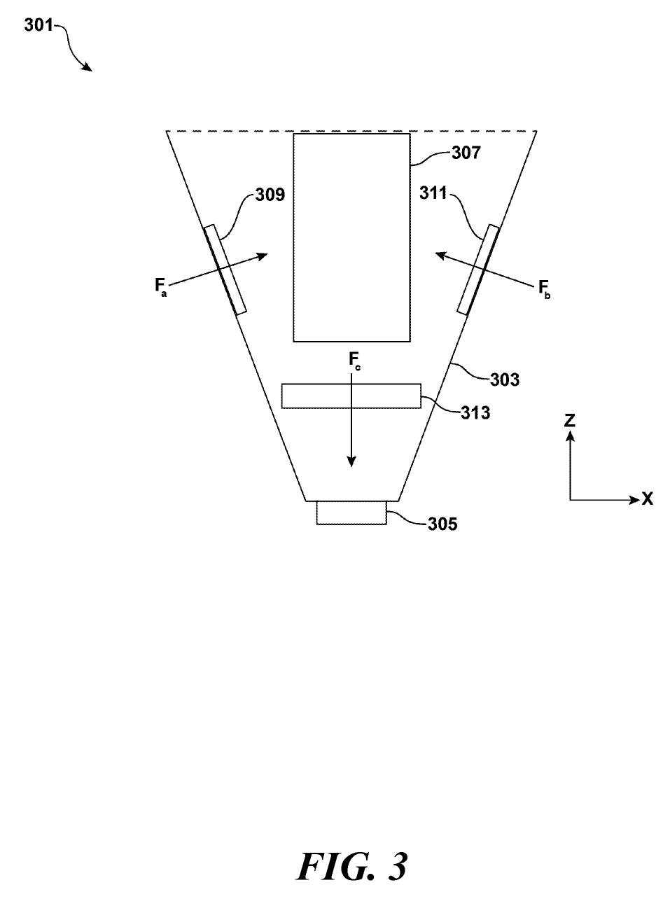

FIG. 3 is an illustration of a particular, non-limiting embodiment of an illumination device 301 with two synthetic jet ejectors positioned similarly to those in FIG. 2, except that they have been tilted to follow the outline of the cone.

The illumination device 301 depicted therein has a cone 303 with a PAR/R standard shape and an electrical/mechanical attachment 305 (this is typically a threaded screw cap and electrical contact of the type that rotatingly engages an Edison socket). An assembly 307 of one or more light sources and optical components are seated within the cone 303. First 309 and second 311 synthetic jet ejectors or synthetic jet actuators are positioned in the cone in an arrangement in which the respective forces Fₐ and F_{b} (and associating moments) are equal in magnitude but opposite in sign, and hence cancel each other out. In this embodiment, and unlike the situation in the illumination device 201 of FIG. 2, there is a net force along the z-axis of the cone 303. However, in this embodiment, a third synthetic jet ejector 313 or synthetic jet actuator is positioned symmetrically about the axis of the cone 303. This synthetic jet ejector 313 can be driven so that its force is opposite in phase and cancels the z-component of the forces and moments of the first 309 and second 311 synthetic jet ejectors. The resulting zero net force and moment give the desired vibration reduction or elimination.

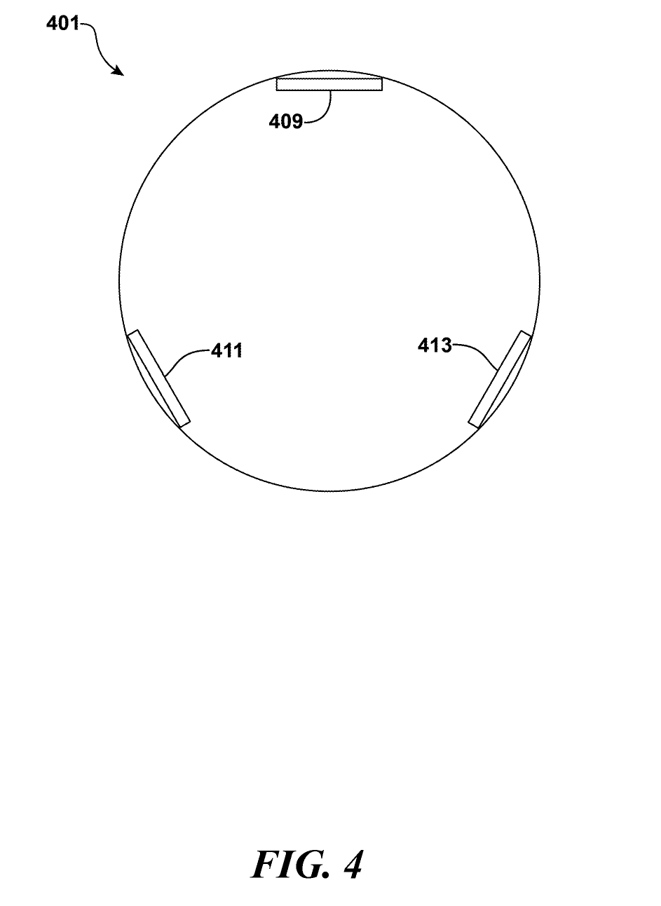

FIG. 4 is an illustration (end view) of a particular, non-limiting embodiment of an illumination device 401 having a configuration featuring a cone 403 or cylinder of the type typical for a standard (PAR/R) light bulb or lighting fixture. In this configuration, three synthetic jet ejectors 409, 411 and 413 or synthetic jet actuators are positioned with 120° degree spacing and with their forces perpendicular to, and passing through, the z-axis of the cone 403. Thus, on balance, and assuming equality of mass and frequency, the x and y force components are cancelled when the three actuators 409, 411 and 413 are driven in phase. The individual net forces pass thru the axis of the cone 403 so there is also zero moment. Thus, vibration is reduced or eliminated, even though there is no single synthetic jet ejector in this configuration that completely cancels out the forces or moments of any other single synthetic jet ejector.

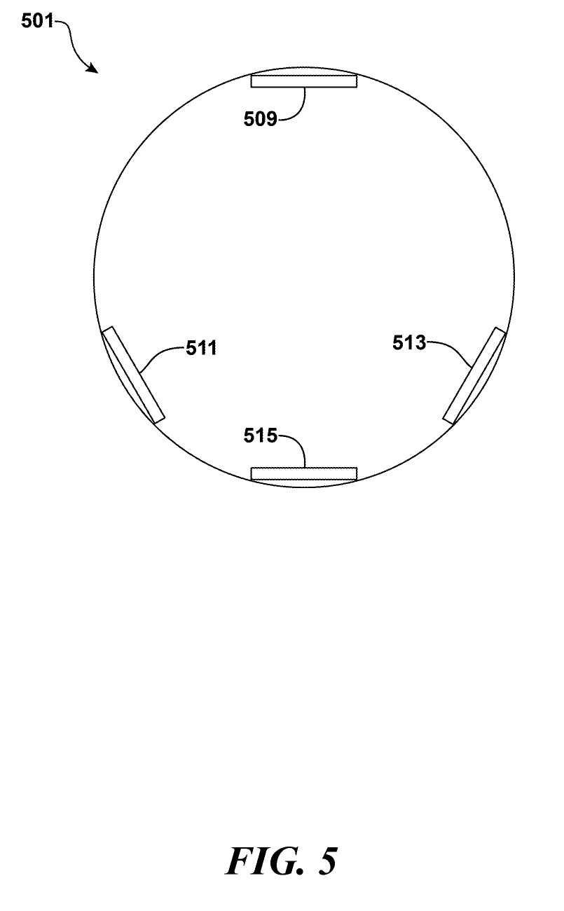

FIG. 5 is an illustration of a particular, non-limiting embodiment of an illumination device 501 having a configuration featuring a cone 503 or cylinder of the type typical for a standard (PAR/R) light bulb or lighting fixture. In this configuration, four synthetic jet ejectors 509, 511, 513 and 515 or synthetic jet actuators are positioned in an arrangement where they are not attached in paired equal and opposite positions, but are mounted with their individual force vectors passing the thru the axis of the cone 503. For this case, zero force is obtained by modifying the magnitude of the displacement drive signals and/or the mass of the moving elements of the synthetic jet ejectors 509, 511, 513 and 515 to give a net zero force. This arrangement provides more package design flexibility to meet external constraints or to optimize cooling, and reduces or eliminates vibration.

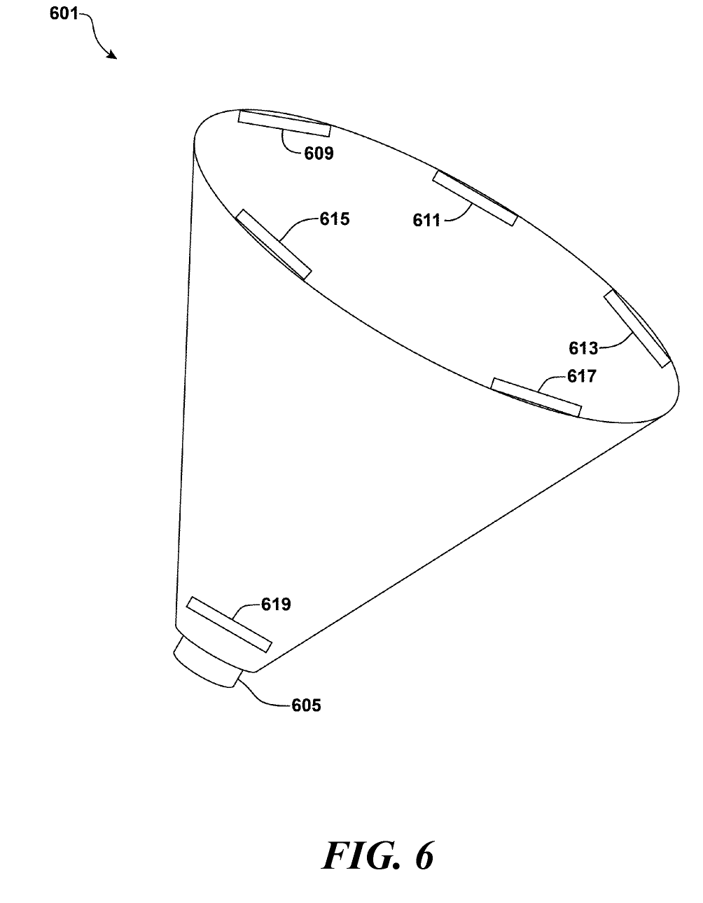

FIG. 6 is an illustration of a particular, non-limiting embodiment of an illumination device in accordance with the teachings herein. The illumination device 601 depicted therein has a cone 603 with a PAR/R standard shape and an electrical/mechanical attachment 605 (this is typically a threaded screw cap and electrical contact of the type that rotatingly engages an Edison socket). In this configuration, five synthetic jet ejectors 609, 611, 613 and 615 or synthetic jet actuators are positioned in an arrangement where they are not attached in paired equal and opposite positions, but are mounted with their individual force vectors passing the thru the axis of the cone 603. The configuration of the illumination device 601 extends the configuration of the illumination device 501 of FIG. 5 to include compensation for the more general case when the synthetic jet ejectors or synthetic jet actuators are mounted such that there is a net force along the z-axis. In this case, the synthetic jet ejector 619 at the base of the cone 603 provides the balancing force similar to the description above for FIG. 3.

In some of the systems and methodologies disclosed herein, an accelerometer may be attached or coupled to the housing or components of interest. The accelerometer signal may then be fed into the electronic control circuit to adjust phase and amplitude ratios between actuators. This approach may allow for the dynamic variable control of systems with dissimilar actuators or non-symmetric systems, thus helping to reduce or minimize vibrations.

It will be appreciated from the foregoing that the novel arrangements of synthetic jet ejectors or actuators described herein provide a more general solution to the vibration minimization in thermal management systems based on synthetic jet ejectors, especially when applied to the geometric, flow, packaging challenges, and other lighting requirements that exist in LED-based illumination devices. The drawings disclosed herein depict embodiments which utilize a cone geometry. However, one skilled in the art will appreciate that the same benefits may be obtained by applying the systems and methodologies disclosed herein to other package shapes and to other applications and products besides LED-based illumination devices.

It will be appreciated that the systems and methodologies disclosed herein may be utilized to minimize or cancel forces or momenta arising from the operation of a synthetic jet ejector. Typically, at least 90% of the forces and/or momenta are cancelled, preferably at least 95% of the forces and/or momenta are cancelled, more preferably at least 98% of the forces and/or momenta are cancelled, and most preferably, at least 99% of the forces and/or momenta are cancelled. The foregoing may also be expressed by stating that P_{F} is essentially zero, wherein P_{F}=100*T_{F}/T_{N}, wherein T_{F}=Σᵢ₌₁ⁿ Fᵢ, wherein T_{N}=Σᵢ₌₁ⁿ |Fᵢ|, and wherein each Fᵢ is one of the n directional components of the forces for all of the synthetic jet ejectors in a device, it being understood that similar relations hold with respect to the momenta.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A method for operating a thermal management system, comprising:
providing a set of synthetic jet actuators A={a₁, . . . , aₙ}, wherein n≧3, and wherein each member of A has a diaphragm which oscillates along a principle axis; and
arranging and operating the members of set A such that they have corresponding forces F₁, . . . , Fₙ at any given time during their operation, wherein any force Fₖ ε {F₁, . . . , Fₙ} has vector components along mutually orthogonal axes x, y and z of Fₖₓ, F_{ky}, and F_{kz}, wherein at least one of the sets Sₓ={|F₁ₓ|, . . . , |Fₙₓ|}, S_{y}={|F_{1y}|, . . . |F_{ny}|} and S_{z}={|F_{1z}|, . . . , |F_{nz}|} has more than one member, and wherein the sum T_{F}=Σᵢ₌₁ⁿ Fᵢ is essentially zero.

2. The method of claim 1, wherein at least two of the sets Sₓ, S_{y} and S_{z} have more than one member.

3. The method of claim 1, wherein all of the sets Sₓ, S_{y} and S_{z} have more than one member.

4. The method of claim 1, wherein T_{F}=0.

5. The method of claim 1, wherein the set of synthetic jet actuators are disposed in an illumination device.

6. The method of claim 5, wherein said illumination device has a conical housing, and wherein at least some of said actuators are disposed on the interior surface of said conical housing.

7. The method of claim 6, wherein said set of synthetic jet actuators includes first and second actuators that are disposed on the interior surface of said conical housing.

8. The method of claim 7, wherein said first and second actuators are equipped with first and second diaphragms that oscillate along first and second axes, respectively, and wherein said first and second axes are perpendicular to said housing.

9. The method of claim 8, wherein said set of synthetic jet actuators includes a third synthetic jet actuator, wherein said third actuator is equipped with a third diaphragm that oscillates along a third axis, wherein said conical housing has a longitudinal axis, and wherein said third axis is parallel to said longitudinal axis.

10. The method of claim 6, wherein said set of synthetic jet actuators includes first, second and third actuators that are disposed on the interior surface of said conical housing, wherein said first, second and third actuators are equipped with first, second and third diaphragms that oscillate along first, second and third axes, respectively, and wherein said first, second and third axes are perpendicular to said housing.

11. The method of claim 10, wherein said first, second and third actuators are spaced apart equally from each other along the interior surface of said conical housing.

12. The method of claim 11, wherein said first, second and third actuators have rotational symmetry about the longitudinal axis of said conical housing.

13. The method of claim 11, wherein said first, second and third actuators have three-fold rotational symmetry about the longitudinal axis of said conical housing.
